(19) United States
(12) Patent Application Publication
(10) Pub. No.: US 2019/0208722 A1
(43) Pub. Date: Jul. 11, 2019

(54) INSTALLATION AND METHOD FOR THE AEROPONIC/HYDROPONIC PRODUCTION OF PLANTS

(71) Applicant: PLANT ADVANCED TECHNOLOGIES PAT, VANDOEUVRE LES NANCY (FR)

(72) Inventors: Jean-Paul René FEVRE, Laneuveville-devant-Nancy (FR); Paul François HANNEWALD, Xeuilley (FR); Benoît Simon MIGNARD, Toulouse (FR)

(73) Assignee: PLANT ADVANCED TECHNOLOGIES PAT, VANDOEUVRE LES NANCY (FR)

(21) Appl. No.: 16/326,961

(22) PCT Filed: Sep. 11, 2017
(86) PCT No.: PCT/EP2017/072690

§ 371 Date: Feb. 21, 2019

(30) Foreign Application Priority Data
Sep. 20, 2016 (FR) 1670537

(51) Int. Cl. A01G 31/04

(52) U.S. Cl. CPC A01G 31/042

(57) ABSTRACT

An installation for the aeroponic/hydroponic production of plants (P) comprises at least a table (1), trays (2) able to move on the table (1) and intended to support the plants (P) so as to transfer the plants (P), the installation being characterized in that it comprises a dipping station (14) comprising a lift for lowering and raising at least one tray (2) between a raised position and a lowered position so as to dip the roots (PR) in a dipping bath (140) containing a liquid in the lowered position for a predetermined length of time.

### FIELD OF THE INVENTION

The invention concerns an installation and a process for the aeroponic or hydroponic production of plants, in particular with a view to extracting recoverable substances such as active substances, in particular for pharmaceutical or cosmetics applications, without any loss of the plants' viability.

### PRIOR ART

A metabolite production process has already been described in document WO 01/33942 whereby plants are cultivated off-ground and the substances of interest are obtained by extraction operations that do not jeopardise the plant. Thus, we obtain worthwhile productivity compared with methods where the whole plant or only certain parts are used leading to its destruction, such as maceration or distillation. According to one of the extraction methods described in this document, we proceed in cycles by growing the plant which develops both its aerial part and its root part, then we perform a root permeabilization step. Then we perform a metabolite recovery step using a liquid placed in contact with the roots by percolation or immersion. After this step, the plants may possibly be rinsed and are put back to grow for a new cycle. The liquid collected is then treated to separate of the metabolites of interest and increase their concentration.

This document does not show the means that can be used to implement this process.

Document JP-H07-99847A shows an off-ground cultivation installation in which the plants are grown in pots supported by trays and which are transferred horizontally from station to station. One of these stations consists of moving the tray above a cutting bar in order to free the pots from the roots growing out of the bottom of the pots.

Such an installation is not suited to the implementation of the previous process.

### OBJECTS OF THE INVENTION

The method explained in document WO 01/33942 needs to be implemented on an industrial scale, which is now the subject of this application.

### DESCRIPTION OF THE INVENTION

With these goals in view, the object of the invention is an installation for the aeroponic/hydroponic production of plants including at least a table, mobile trays on the table designed to support the plants and transfer the plants to the installation's different stations, the roots of the plants being suspended under the trays, the installation being characterised by a soaking station including an elevator for lowering and lifting at least one tray between a high position and a low position in order to soak the roots in a soaking tank containing a liquid for a predetermined length of time in the down position.

The plants on the tray can be handled as a large assembly at different places according to their stage of development. The tray serves as separation between the root part underneath and the aerial part above. This complete assembly is therefore placed on the elevator and the roots are soaked in the liquid which recovers the metabolites by transfer into the liquid. These means are simple to implement and are highly efficient, owing to the large number of plants treated in a single operation.

According to a design principle, the table includes two raised rails parallel to each other in a longitudinal horizontal direction, the trays including rollers for running along the rails, the elevator including two rail sections aligned with the table's rails when the elevator is in the raised position. With rollers and rails such as these, the trays can be moved easily, for example by being pushed by hand, without any great effort. The trays thus roll on to the elevator where they are taken on.

According to an improvement, the first of the two rails comprises a first flat, horizontal bearing surface, the second of the two rails comprises a second raised bearing surface, each tray including at least one first cylindrical roller for running on the first surface and at least two second grooved rollers whose cross-section is complementary with the second surface to ensure linear guidance of the tray on the table. Such a system guarantees linear guidance from one side of the tray, by the grooved rollers, without any stress on the opposite side, in such a way that is tolerant to any parallelism defects and differences of thermal dilation or to constraint deformations.

According to another design principle, the table includes a sealing tarpaulin raised against the rail and fastened by an attachment plate, the tarpaulin extending upwards in the form of a lip curved towards the other rail, resting under the trays on a lower sealing surface extending horizontally. The sealing serves to limit the passing of light under the trays and thus avoid the development of micro-organisms by photosynthesis. It also serves to contain the different types of liquid used to feed the plants by their roots or for their treatment, in particular when this is diffused by mist. This sealing is achieved very simply by an extension of the tarpaulin used to delimit a space under the trays.

According to an improvement in the installation, the table includes a cutting station, the cutting station including a cutting bar extending longitudinally and being transversally mobile to shorten one of the parts of the plant. The inventors have realised that it is possible to harvest part of the plants to extract the substances of interest without their survival being compromised. This harvesting comes in addition to the recovery by soaking in order to recover other substances or other concentrations of substances. The harvested parts can then be treated by filtering, decoction, maceration or distillation, depending on the nature of the plants and the substances you want to recover.

In a variant, the cutting station includes a cutting bar that extends transversally and is mobile longitudinally with respect to the tray.

According to an improvement, the cutting bar extends under the level of the trays to shorten the root part, the cutting station also including a collection tank for recovering the cut part of the plants.

According to a design principle, the collection tank is tilted and comprises a gutter in the lower part. The crop is therefore easy to gather together, using simple means.

Preferably the height of the cutting bar should be adjustable. This will therefore make it possible to adapt harvesting to the plants' variety and stage of development.

According to an improvement, the installation includes at least one transfer trolley to transport at least one of the trays from one table to the other, and at the end of each table a transversal guide for determining the position of the trolley with respect to the table. The transverse guide, which may be a rail on the floor, makes it possible to determine the trolley's position precisely and maintain this position when the tray is being manoeuvred.

According to a design principle, the trolley includes parallel rail sections, separated by the same distance as the table's rails for prolonging the table's support rails and receive at least one of the trays, and locks at the end of the trolley's rail sections to block the tray(s) in position.

According to another improvement, the installation includes a test station designed to receive one of the trays, the station being divided transversely into compartments by vertical walls adjusted under the tray, each compartment including an independent liquid circuit for feeding the plants located above said compartment independently from the other compartments. Such a station makes it possible to use the same trays to conduct comparative tests on subdivisions of the tray, by submitting them to different conditions which can be controlled particularly by the nature of the liquid used to feed the plants, and by the frequency and length of watering.

The object of the invention also includes an aeroponic/hydroponic plant production process in which we place the plants on trays with the aerial part of the plant above the tray and the root part underneath, and the trays on tables forming a retention zone for collecting any excess liquid diffused to the plants. We transfer the trays on the tables to different stations in the installation, the process being characterised by the fact it includes a soaking step during which we lower the tray in order to soak the roots in a soaking tank containing a liquid for a predetermined length of time, we raise the tray and repeat the operation with other trays, and then we collect the liquid contained in the soaking tank.

According to an improvement, the soaking step is preceded by a stimulation step during which at least the root parts receive a stimulation liquid. The stimulation liquid contains, for example, salts, surface-active agents, detergents, solvents, elicitors of fungal or bacterial origin, derivatives of jasmonic acid, ethylene generators, chitins, chitosans or mixtures thereof. The stimulation step may also be carried out using a nutrient solution deficient in nitrogen, for 2 to 6 weeks before the soaking step. This stimulation step makes it possible to significantly increase the metabolite content in the roots and also promote the flow comprising the metabolites leaving the roots during the soaking step and this, without any loss in the plant's viability so it can be put back to grow.

According to an improvement, the soaking step is preceded by a washing step in which the liquid diffused to the plants is fresh water, following the possible stimulation step. We thus limit the addition of the elements contained in the nutrient solution or in any possible stimulation solution at the time of the soaking step.

In a complementary way, the soaking step is followed by a cutting step during which the aerial part or the root part of the plants is partially cut to harvest the cut part. In addition to the extraction of the substances during the soaking step, we extract those contained in the cut part.

According to an improvement, we extract the substances of interest from the cut part by maceration, decoction or distillation.

### BRIEF DESCRIPTION OF THE FIGURES

To better understand the invention, reference is made to the description which follows and to the appended drawings, among which:

FIG. 1 is a schematic diagram of an installation that conforms to one of the invention's accomplishment modes;

FIG. 2 is a cross-sectional view per line II-II of FIG. 1;

FIG. 3 is a view of a detail of a trolley that is part of the installation;

FIG. 4 is a view similar to FIG. 2 of a test station that is part of the installation.

### DETAILED DESCRIPTION

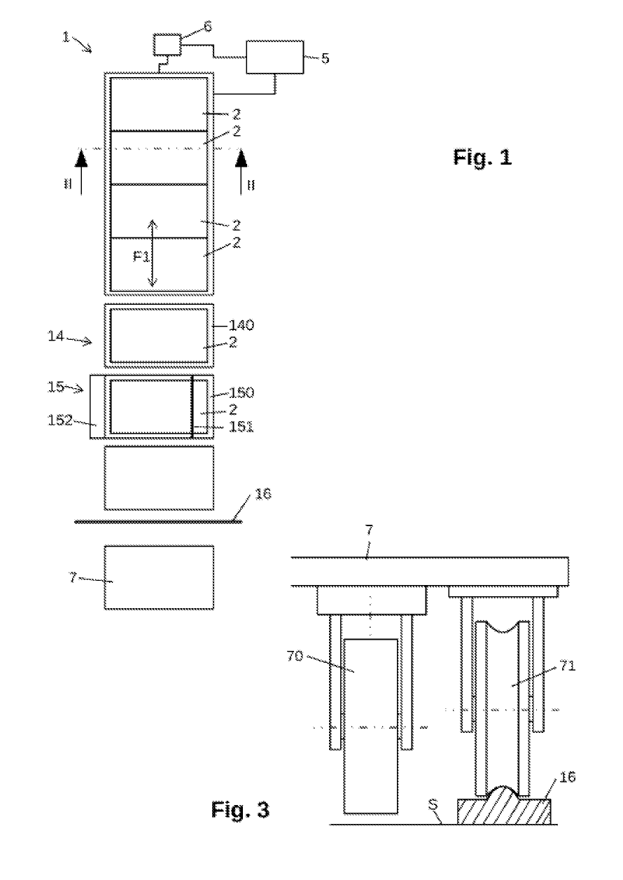

An aeroponic/hydroponic installation for producing plants P is shown schematically in FIG. 1. The installation consists of a table 1 on which trays 2 are provided, mobile in horizontal translation along longitudinal direction F1. The trays 2 are designed to support plants P during their growth and to transfer the plants P to the installation's different stations. Only one table 1 is shown in the figure, but it must be understood that an installation may comprise many more tables to increase the production surface area. The installation may be set up in a greenhouse for example.

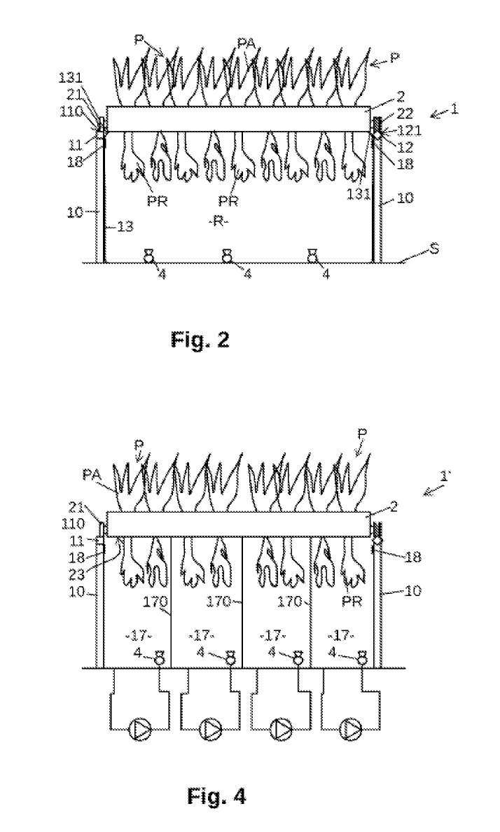

As shown in FIG. 2, table 1 includes side walls along which an opaque sealing tarpaulin 13 is attached extending from one side to the other, passing on the floor S to form a retention zone R.

Table 1 includes two raised rails 11, 12 parallel to each other along longitudinal direction F1, supported by the side walls 10. The trays 2 include rollers 21, 22 to roll along rails 11, 12. The first of the rails 11 is a tube with a square cross-section that includes a first horizontal, flat rolling surface. The other rail 12 is a tube also with a square cross-section, fixed with sides tilted at 45°, in such a way that it has a second embossed rolling surface 121, with an inverted V-shape. Each tray 2 has two first cylindrical rollers 21 for rolling along the first surface and at least two second grooved rollers 22 whose cross-section is complementary to the second surface 121, therefore V-shaped, to ensure linear guidance of tray 2 on table 1.

The sealing tarpaulin 13 is raised against rail 11, 12 and fixed with an attachment plate 18. The sealing tarpaulin 13 extends upwards in a lip shape 131 curving towards the other rail 12, 11, coming into contact under the trays 2, over a lower sealing surface 23 extending horizontally. A closed space is thus delimited under the trays 2 and between the floor S and the walls 10.

The roots PR of plants P are suspended under trays 2 in this space. In order to feed the plants P with a liquid, not shown, spray ramps 4 are placed on the floor S on the tarpaulin in such a way as to intermittently produce a mist, in a way known in aeroponics. The excess liquid is collected on sealing tarpaulin 13 and recycled. The ramps 4 are fed from a tank 5 and a pump 6 delivering the liquid under pressure.

According to the invention, the installation includes a soaking station 14 including an elevator, not shown, to lower and raise at least one tray 2 between a high position and a low position in order to soak the roots PR in the soaking tank 140 containing a liquid. Soaking is carried out for a predetermined length of time by maintaining the elevator and the tray 2 that it supports in the low position. The elevator has two sections of rails aligned with rails 11, 12 of table 1 when the elevator is in the high position. Thus, we can transfer a tray 2 between the elevator and the other part of table 1 simply by rolling tray 2. The travel range is chosen so that the longest of the roots PR are not in the soaking tank 140 in the high position.

Table 1 also includes a cutting station 15 placed just beside the soaking station. The cutting station includes a cutting bar 151 extending longitudinally in direction F1 and transversely mobile, that is to say in direction F2 perpendicular to the longitudinal direction F1. The cutting station also includes a collection tank 150 extending under the whole extent of tray 2. The collection tank 150 is tilted and comprises a gutter 152 in its lower part. Cutting bar 151 makes it possible to shorten the root part PR of the plants P on a tray 2, in such a way as to receive the cut part of plants P in collection tank 150. The cutting bar 151 may be used on several trays 2 together. The height of the cutting bar 151 can be adjusted to make it possible to choose the residual length of the roots PR after cutting. The cutting bar may be placed transversely and cut either with the movement of tray 2, or by its own movement. It may also be placed above the level of the trays in order to cut the aerial part PA of plants P. In this case, the cut part is not recovered in the collection tank, but by hand on the tray using a rake, or mechanically, or with an accessory such as a conveyor belt to bring the cut parts to the edge of table 1.

The installation also includes at least one transfer trolley 7 to transport at least one of the trays 2 from one of the tables 1 to the other. As shown in FIG. 3, the trolley 7 is fitted with self-steering rollers 70 allowing it to roll on the floor in various directions. At the end of each table 1 the installation includes a transversal guide for determining the position of the trolley 7 with respect to the table 1. The guide 16 takes the form of a rail fastened to the floor. The trolley 7 includes rollers for the rail 71 designed to engage on the guide 16. The guide 16 is placed at sufficient height to ensure that, when the rollers of rail 71 engage on guide 16, the trolley 7 is raised and the self-steering rollers 70 are lifted off the floor. Thus, the weight of trolley 7 is transferred to guide 16, which ensures proper guidance of the trolley 7. The rollers on rail 71 are also sufficiently high to ensure they do not touch the floor when the trolley 7 is resting on the self-steering rollers 70.

Furthermore, the trolley 7 comprises sections of parallel rails, not shown, separated by the same distance as the rails 11, 12 of table 1 to prolong the rails of table 1 and receive at least one of the trays 2, and locks, not shown, at the ends of the rail sections of trolley 7 to lock the tray(s) 2 in position. The locks are formed for example by a plate mounted pivoting around a longitudinal axis and including an arc-shaped notch with the same shape as the rail. The plate forms an obstacle at the level of the rail section when it is pushed home against the rail, but releases it by pivoting.

The installation includes a test station 1′ designed to receive one of the trays 2, shown in FIG. 4. The station is divided transversely into four compartments 17 by vertical walls 170 adjusted under tray 2, each compartment 17 including an independent liquid circuit for feeding the plants P placed above said compartment 17 independently from the other compartments 17. The test station 1′ also has rails 11, 12 to receive tray 2 and a flap, not shown, which, in a first position, makes it possible to let the roots PR pass into compartments 17 when the tray 2 is put in place, and a second position in which the compartments 17 are closed.

In production, the plants P are placed on the trays 2, by means of supports, not shown, with the aerial part PA above the tray 2 and the root part PR underneath. The trays 2 are placed on the tables, and the installation may have several tables placed side by side. The plants P are fed with a nutrient solution which is suited to the cultivated plants P and their stage of development. The nutrient solution may be dispensed from above the trays 2 by watering, or by creating a mist in the space under the trays 2.

Between 1 and 14 days before harvesting (soaking step), the nutrient solution is completed by a stimulation liquid in order to increase the production of substances of interest and promote the release of these substances by the plant P.

When the plants P are ready for harvesting, the roots PR are washed with water in order to eliminate the residues of nutrient solution (completed by the stimulation liquid or the liquid deficient in nitrogen). This washing step is carried out for example upstream of the elevator.

Then, we proceed with a soaking step in which we move one of the trays 2 on to the elevator by rolling it along the sections of rail, and lower the tray 2 using the elevator so as to soak the roots PR in the soaking tank 140 containing a liquid for a predetermined length of time, and we raise the tray 2. We can repeat the operation with other trays 2, then collect the liquid contained in the soaking tank 140.

The tray 2 which has just been treated in the soaking step is moved to the cutting station 15. The cutting bar 151 is activated and moved under tray 2 so as to cut the root part PR that extends below the cutting plane. The cut part of the roots PR falls into the collection tank 150. The tray 2 is removed and placed on a table 1 and returned to cultivation. The roots are pushed by hand into the gutter 152 so they can be recovered and treated using a conventional method.

The invention is not limited to the accomplishment mode which has been described only as an example. The movement of the trays 2 can be motorised and automated, as can the operation of the elevator.

1. An installation for the aeroponic/hydroponic production of plants including at least one table, mobile trays on the table designed to support the plants and transfer the plants to the installation's different stations, the roots of plants being suspended under the trays, the installation being characterised by the fact that it includes a soaking station with an elevator for lowering and raising at least one tray between a high position and a low position so as to soak the roots in a soaking tank containing a liquid for a predetermined length of time in the low position.

2. The installation according to claim 1, wherein the table includes two raised rails parallel to each other along a horizontal longitudinal direction, the trays including rollers to roll on the raised rails, the elevator including two sections of rails aligned with the raised rails of the table when the elevator is in the high position.

3. The installation according to claim 2, wherein the first of the raised two rails includes a first flat, horizontal rolling surface, the second of the two raised rails includes a second embossed rolling surface, each tray including at least one cylindrical roller to roll on the first surface and at least two grooved rollers whose cross-section is complementary with the second surface to ensure a linear guidance of the tray on the table.

4. The installation according to claim 1, wherein the table includes a sealing tarpaulin raised against the raised rail and fixed by an attachment plate, the tarpaulin extending upwards in a lip-shape curving towards the other rail, coming into contact under the trays, on a lower sealing surface extending horizontally.

5. The installation according to claim 1, wherein the table includes a cutting station, the cutting station including a cutting bar extending longitudinally and being mobile transversely to shorten one of the parts of the plants.

6. The installation according to claim 1, wherein the table includes a cutting station, the cutting station including a cutting bar extending transversely and being mobile longitudinally with respect to the tray to shorten one of the parts of the plants.

7. The installation according to claim 5, wherein the cutting bar extends under the level of the trays to shorten the root part, the cutting station also including a collection tank for receiving the cut part of the plants.

8. The installation according to claim 7, wherein the collection tank is tilted and includes a gutter in its lower part.

9. The installation according to claim 5, wherein the cutting bar is height-adjustable.

10. The installation according to claim 1, the installation further including: at least one transfer trolley capable of transporting at least one of the trays from one of the tables to the other; and at the end of each table a transversal guide capable of determining the position of the trolley with respect to the table.

11. The installation according to claim 10, wherein the transfer trolley includes: parallel rail sections, with the same separation distance as the rails of table capable of prolonging the rolling rails of table and receiving at least one of the trays; and locks at the ends of the rail sections of the trolley configured to block the position of the tray(s).

12. The installation according to claim 1, the installation further including: a test station designed to receive one of the trays, the test station being divided transversely into compartments by vertical walls adjusted under the tray, each compartment including an independent liquid circuit for feeding the plants placed above said compartment independently from the other compartments.

13. A process for the aeroponic/hydroponic production of plants, comprising:
placing plants on the one or more trays with an aerial part of the plant above the tray and a root part of the plant underneath the tray;
placing the tray(s) on one or more tables to forming a retention zone for collecting an excess of a liquid diffused towards the plants;
transferring the tray(s) on the tables to one or more different stations in the installation of claim 1;
wherein the process further comprises:
a soaking step in which the root part of the plant in a first tray is soaked in a soaking tank containing a liquid for a predetermined length of time;
raising the first tray and repeating the operation with any other trays; and
collecting the liquid contained in the soaking tank.

14. The process according to claim 13, whereby the soaking step is preceded by a stimulation step wherein at least the root part of the plants are provided a stimulation liquid.

15. The process according to claim 13 whereby the soaking step is preceded by a washing step comprising diffusing a liquid to the plants, wherein the diffused liquid is fresh water, following the possible stimulation step.

16. The process according to claim 13 whereby the soaking step is followed by a cutting step comprising partially cutting the aerial part or the root part of the plants to harvest a cut part.

17. The process according to claim 16, further comprising an extracting step comprising extracting one or more substances of interest from the cut part by maceration, decoction or distillation.

18. The installation according to claim 6, wherein the cutting bar extends under the level of the trays to shorten the root part, the cutting station also including a collection tank-for receiving the cut part of the plants.

19. The installation according to claim 18, wherein the collection tank is tilted and includes a gutter in its lower part.
